(19) United States
(12) Patent Application Publication
(10) Pub. No.: US 2011/0202940 A1
(43) Pub. Date: Aug. 18, 2011

(54) MOTOR, DISK DRIVE APPARATUS AND MOTOR MANUFACTURING METHOD

(75) Inventors: Haruhiko Ito, Minami-ku (JP); Takuya Yamane, Minami-ku (JP)

(73) Assignee: NIDEC CORPORATION, Kyoto (JP)

(21) Appl. No.: 13/026,814

(22) Filed: Feb. 14, 2011

(30) Foreign Application Priority Data
Feb. 18, 2010 (JP) 2010-033364

(51) Int. Cl. G11B 17/028; H02K 37/24; H02K 37/14; H02K 15/00

(52) U.S. Cl. 720/695; 310/48; 29/596; G9B/17.006

(57) ABSTRACT

A motor includes a turntable and a rotor holder unified with each other by insert-molding. The turntable includes a protrusion portion protruding radially outward beyond a cylinder portion and a substantially cylindrical covering portion extending downward from an radial inner end of the protrusion portion to cover an outer circumferential surface of the cylinder portion. The rotor holder has a radial outer end portion arranged in the same radial position as an outer circumferential surface of the covering portion or arranged radially inward of the outer circumferential surface of the covering portion. For this reason, a sliding contact area between a mold and the rotor holder is reduced. This helps suppress sliding contact between the mold and the rotor holder during a mold releasing process, consequently suppressing degradation of the mold.

### BACKGROUND OF THE INVENTION

1. Field of the Invention

The present invention relates to a motor, a disk drive apparatus and a motor manufacturing method.

2. Description of the Related Art

A brushless motor for rotating a disk is mounted to a disk drive apparatus such as an optical disk drive or the like.

As one example of conventional motors, there is available a motor of the type in which a magnetic rotor yoke is attached to the bottom portion of a synthetic-resin-made turntable by insert-molding or other methods. As another example of the conventional motors, there is available a motor of the type in which, when molding a turntable, a rotor yoke and a shaft are arranged within a mold and assembled together by insert-molding.

In the conventional motors, however, the outer circumferential surface of a rotor yoke is exposed to the outside. Therefore, it is believed that the outer circumferential surface of the rotor yoke makes direct sliding contact with the mold during the insert-molding process. As a result, the outer circumferential surface of the rotor yoke and the mold make sliding contact with each other when the turntable and the rotor yoke are removed from the mold.

If the outer circumferential surface of the rotor yoke and the mold make sliding contact with each other, the sliding contact surface of the mold is worn, which shortens the lifespan of the mold.

For this reason, it is important to suppress the sliding contact between the mold and the rotor holder in the event that the rotor holder and the turntable are unified by insert-molding.

### SUMMARY OF THE INVENTION

In accordance with a first aspect of the invention, there is provided a motor, including: a stationary unit; and a rotary unit supported by the stationary unit for rotation with respect to the stationary unit, wherein the rotary unit includes a shaft arranged along a vertically-extending center axis, a metal-made rotor holder having a cylinder portion arranged in a coaxial relationship with the center axis, a first magnet fixed to an inner circumferential surface of the cylinder portion, a resin-made turntable unified with the rotor holder by insert-molding and a disk support portion fixed to the turntable and provided with an upper surface on which a disk is to be placed, the stationary unit includes a bearing unit arranged to rotatably support the shaft and a stator radially opposed to the first magnet, the turntable includes a protrusion portion protruding radially outward beyond the cylinder portion of the rotor holder to support the disk support portion from below and a substantially cylindrical covering portion extending downward from an radial inner end of the protrusion portion to cover an outer circumferential surface of the cylinder portion, and the rotor holder has a radial outer end portion arranged in the same radial position as an outer circumferential surface of the covering portion or arranged radially inward of the outer circumferential surface of the covering portion.

In accordance with a second aspect of the invention, there is provided a method for manufacturing a motor including a metal-made rotor holder having a cylinder portion arranged in a coaxial relationship with a center axis and a resin-made turntable having a protrusion portion protruding radially outward at the upper side of the cylinder portion, the method including: disposing the rotor holder within a cavity defined between a pair of molds; allowing a molten resin to flow into the cavity; solidifying the resin in the cavity into the turntable to produce the turntable and the rotor holder unified together; and removing the turntable and the rotor holder unified together from the molds, wherein one of the molds includes an inner circumferential surface greater in diameter than an outer circumferential surface of the cylinder portion, and the rotor holder is disposed in said one of the molds in such a way that the outer circumferential surface of the cylinder portion and the inner circumferential surface of said one of the molds are opposed to each other through a substantially cylindrical gap forming a portion of the cavity.

With such configuration, the sliding contact area between the insert-molding mold and the rotor holder is reduced. This helps suppress sliding contact between the mold and the rotor holder during the mold releasing process, consequently suppressing degradation of the mold.

Further, the outer circumferential surface of the cylinder portion of the rotor holder is covered with a resin and the sliding contact area between the mold and the rotor holder is reduced. This helps suppress sliding contact between the mold and the rotor holder during the mold releasing process, consequently suppressing degradation of the mold.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a vertical section view showing a motor in accordance with one preferred embodiment of the present invention.

FIG. 2 is a vertical section view showing a disk drive apparatus.

FIG. 3 is a vertical section view showing a brushless motor in accordance with one preferred embodiment of the present invention.

FIG. 4 is a partial vertical section view showing the outer circumferential portion of a rotary unit and its vicinities of the brushless motor.

FIG. 5 is a flowchart illustrating insert-molding steps in accordance with one preferred embodiment of the present invention.

FIG. 6 is a section view showing one insert-molding state.

FIG. 7 is a section view showing another insert-molding state.

FIG. 8 is a section view showing a further insert-molding state.

FIG. 9 is a section view showing a still further insert-molding state.

FIG. 10 is a vertical section view showing a brushless motor in accordance with another preferred embodiment of the present invention.

FIG. 11 is a partial vertical section view showing a rotary unit of the brushless motor shown in FIG. 10.

FIG. 12 is a section view showing one insert-molding state.

FIG. 13 is a section view showing another insert-molding state.

FIG. 14 is a section view showing a further insert-molding state.

FIG. 15 is a section view showing a still further insert-molding state.

FIG. 16 is a partial vertical section view showing a flange portion and its vicinities in accordance with one modified embodiment.

FIG. 17 is a partial vertical section view showing a flange portion and its vicinities in accordance with another modified embodiment.

FIG. 18 is a partial vertical section view showing the outer circumferential portion of a rotary unit and its vicinities in accordance with further modified embodiment.

FIG. 19 is a vertical section view showing a brushless motor in accordance with still further modified embodiment.

FIG. 20 is a vertical section view showing another brushless motor in accordance with yet still further modified embodiment.

FIG. 21 is a vertical section view showing a further brushless motor in accordance with yet still further modified embodiment.

### DETAILED DESCRIPTION OF THE INVENTION

Hereinafter, preferred embodiments of the present invention will now be described with reference to the accompanying drawings. In the following description on the shape and positional relationship of individual members, the direction running along the center axis of a motor will be referred to as “vertical direction” and the side of a turntable at which a disk is arranged will be referred to as “upper”. However, these definitions are presented merely for the sake of convenience in description and are not intended to limit the in-use postures of the motor and the disk drive apparatus of the present invention.

### 1. Motor of One Preferred Embodiment

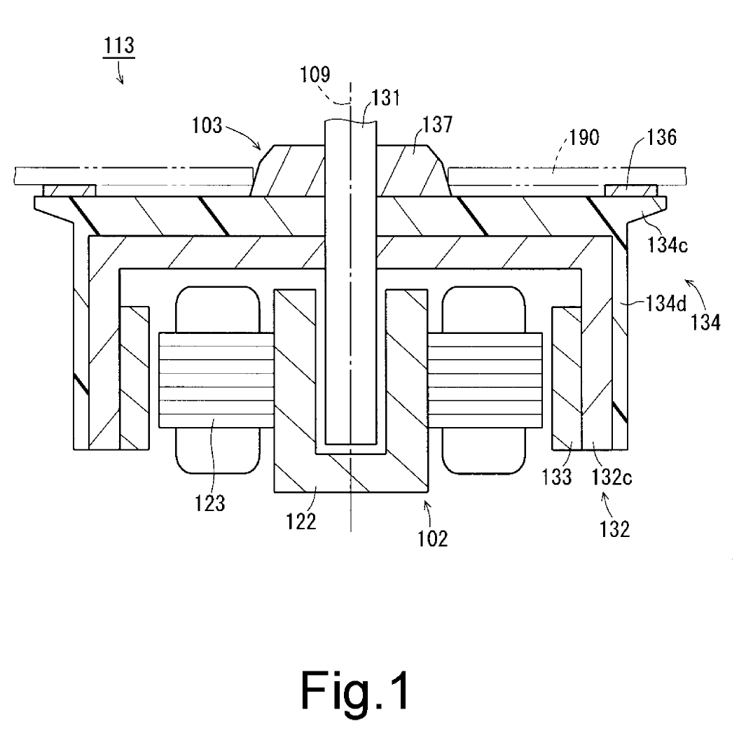

FIG. 1 is a vertical section view showing a motor 113 according to one preferred embodiment of the present invention. As shown in FIG. 1, the motor 113 preferably includes a stationary unit 102 and a rotary unit 103. The rotary unit 103 is rotatably supported with respect to the stationary unit 102.

The stationary unit 102 preferably includes a bearing unit 122 and a stator 123. The bearing unit 122 is a unit arranged to rotatably support the shaft 131. The stator 123 is a member arranged to generate magnetic flux with a drive current supplied from the outside. The rotary unit 103 preferably includes a shaft 131, a rotor holder 132, a first magnet 133, a turntable 134, a disk support portion 136 and a centering portion 137.

The shaft 131 is arranged to extend along a vertically-extending center axis 109. The rotor holder 132 is a metal-made member rotating together with the shaft 131. The rotor holder 132 preferably includes a cylinder portion 132c arranged in a coaxial relationship with the center axis 109. The first magnet 133 is fixed to the inner circumferential surface of the cylinder portion 132c of the rotor holder 132. The first magnet 133 is radially opposed to the stator 123.

The turntable 134 is a resin-made member and is unified with the rotor holder 132 by insert-molding. The disk support portion 136 is fixed to the turntable 134. A disk 190 is placed on the disk support portion 136. The centering portion 137 is arranged radially inward of the disk support portion 136 and above the turntable 134. The centering portion 137 supports the inner circumferential portion of the disk 190.

The turntable 134 preferably includes a protrusion portion 134c and a covering portion 134d. The protrusion portion 134c is a portion positioned above the cylinder portion 132c of the rotor holder 132 and radially outward of the cylinder portion 132c. The disk support portion 136 is supported on the protrusion portion 134c. The covering portion 134d is a substantially cylindrical portion extending downwards from the radial inner end of the protrusion portion 134c. The outer circumferential surface of the cylinder portion 132c of the rotor holder 132 is covered with the covering portion 134d.

In the example illustrated in FIG. 1, the radial outer end of the rotor holder 132 is arranged radially inward of the outer circumferential surface of the covering portion 134d. Alternatively, the radial outer end of the rotor holder 132 may be arranged in the same radial position as the outer circumferential surface of the covering portion 134d.

The steps of molding the rotor holder 132 and the turntable 134 into one piece by insert-molding in the manufacturing process of the motor 113 are as follows. First, a pair of molds is prepared in advance. One of the molds has an inner circumferential surface greater in diameter than the outer circumferential surface of the cylinder portion 132c of the rotor holder 132. The rotor holder 132 is disposed within a cavity defined between the molds. In this connection, the rotor holder 132 is disposed so that the outer circumferential surface of the cylinder portion 132c and the inner circumferential surface of one of the molds can oppose to each other through a substantially cylindrical gap forming a portion of the cavity.

Then, a molten resin is allowed to flow into the cavity. The turntable 134 is formed by solidifying the resin filled in the cavity. As a consequence, the rotor holder 132 and the turntable 134 are unified together. Thereafter, the rotor holder 132 and the turntable 134 thus unified are removed from the molds.

In the insert-molding steps noted above, the resin is solidified in a state that it is interposed between the inner surfaces of the molds and the cylinder portion 132c of the rotor holder 132. Consequently, the outer circumferential surface of the cylinder portion 132c of the rotor holder 132 is covered with a resin layer, i.e., the covering portion 134d. This reduces the contact area between the molds and the rotor holder 132, thereby suppressing the sliding contact between the molds and the rotor holder 132 which may occur when the rotor holder 132 and the turntable 134 unified together are removed from the molds. As a result, it becomes possible to suppress degradation of the molds. Thus, the number of times of the insert-molding operations that can be performed by the same molds gets closer to the number of times of molding operations that can be performed by the molds of the same shape without insert-molding.

### 2. Specific Preferred Embodiment

<2-1. Configuration of Disk Drive Apparatus>

Next, description will be made on a specific preferred embodiment of the present invention.

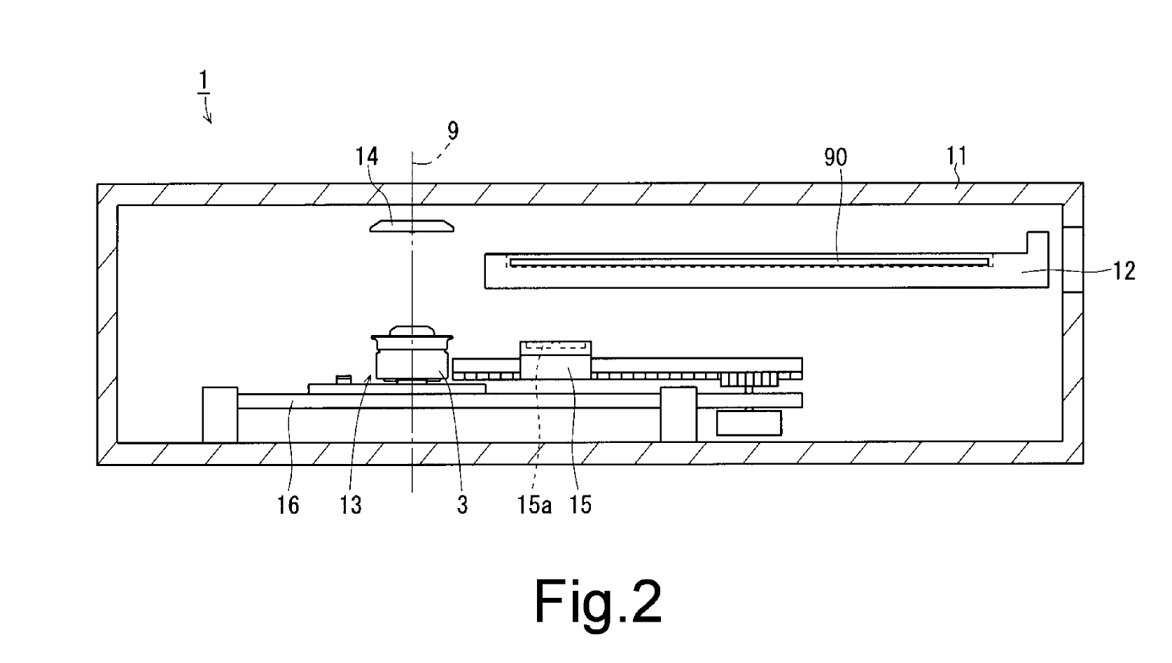

FIG. 2 is a vertical section view showing a disk drive apparatus 1. The disk drive apparatus 1 is an apparatus designed to perform information reading and writing tasks with respect to an optical disk 90 (hereinafter just referred to as “disk 90”) while rotating the disk 90. The disk drive apparatus 1 preferably includes an apparatus housing 11, a disk tray 12, a brushless motor 13, a clamper 14 and an access unit 15.

The apparatus housing 11 is a frame arranged to accommodate the disk tray 12, the brushless motor 13, the clamper 14 and the access unit 15 therein. The disk tray 12 is a mechanism arranged to convey the disk 90 between the inside and the outside of the apparatus housing 11. A chassis 16 is provided within the apparatus housing 11. The brushless motor 13 is fixed to the chassis 16. The disk 90 is conveyed by the disk tray 12 and placed on the brushless motor 13. The disk 90 is held between the rotary unit 3 of the brushless motor 13 and the clamper 14. Thereafter, the disk 90 is rotated about the center axis 9 by the brushless motor 13.

The access unit 15 preferably includes a head 15a having an optical pickup function. The access unit 15 performs information reading and writing tasks with respect to the disk 90 by moving the head 15a along the recording surface of the disk 90 held on the brushless motor 13. Alternatively, the access unit 15 may perform any one of the information reading and writing tasks with respect to the disk 90.

<2-2. Configuration of Brushless Motor>

Next, description will be made on the configuration of the brushless motor 13.

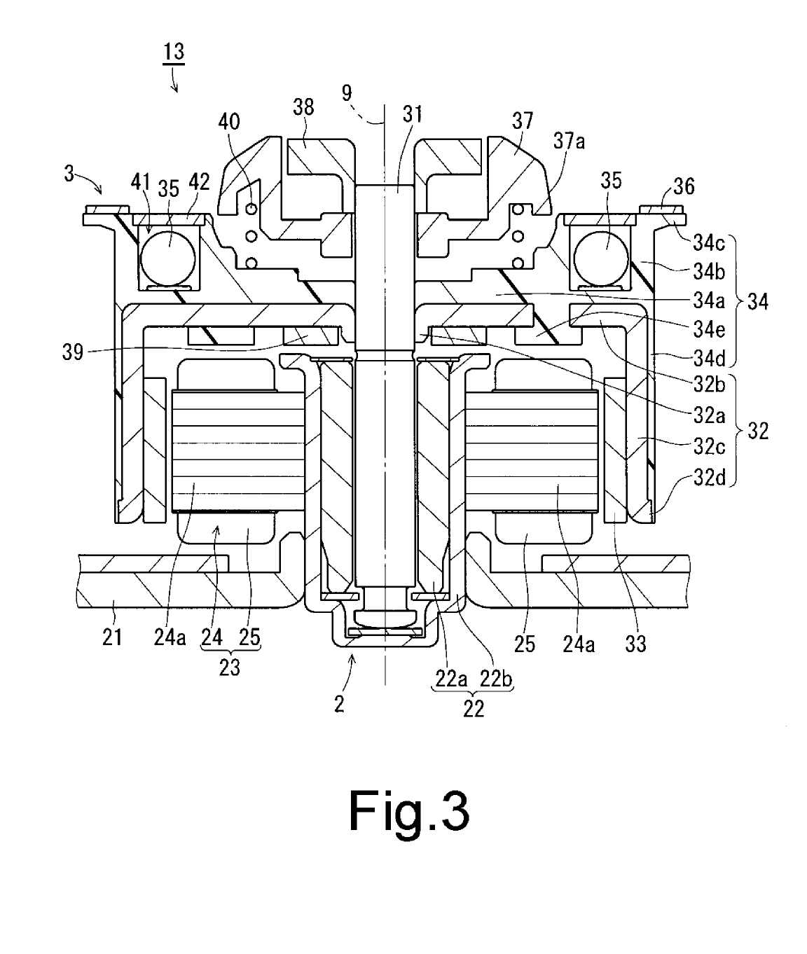

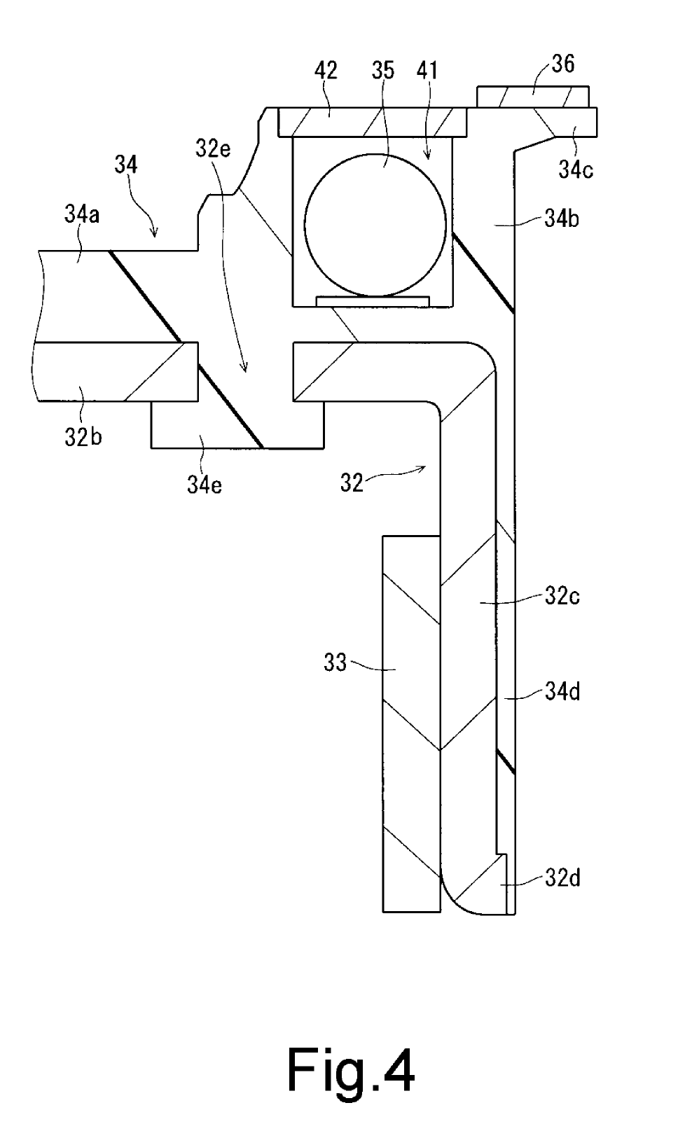

FIG. 3 is a vertical section view showing the brushless motor 13. As shown in FIG. 3, the brushless motor 13 preferably includes a stationary unit 2 and a rotary unit 3. The stationary unit 2 is fixed to the chassis 16 of the disk drive apparatus 1. The rotary unit 3 is rotatably supported with respect to the stationary unit 2. FIG. 4 is a partial vertical section view showing the outer circumferential portion of the rotary unit 3 and its vicinities. The following description will be made by appropriately referring to FIG. 4 as well as FIG. 3.

The stationary unit 2 preferably includes a base member 21, a stationary bearing unit 22 and a stator unit 23. The stationary bearing unit 22 is fixed to the base member 21. The stationary bearing unit 22 is a mechanism arranged to rotatably support a shaft 31. The stationary bearing unit 22 preferably includes a sleeve 22a and a sleeve housing 22b. The sleeve 22a is a substantially cylindrical member arranged to surround the outer circumferential surface of the shaft 31. The sleeve housing 22b is a substantially cup-shaped member arranged to accommodate the sleeve 22a therein. The stator unit 23 preferably includes a stator core 24 having a plurality of tooth portions 24a, and coils 25 wound around the respective tooth portions 24a.

The rotary unit 3 preferably includes the shaft 31, a rotor holder 32, a rotor magnet 33, a turntable 34, a plurality of balls 35, a disk support portion 36, a cone 37, a yoke 38 and a preload magnet 39. The shaft 31 is a substantially cylindrical columnar member vertically extending along the center axis 9. The rotor holder 32 is a member fixed to the shaft 31 for rotation with the shaft 31.

The rotor holder 32 preferably includes a fastening portion 32a, an upper cover portion 32b, a cylinder portion 32c and a flange portion 32d. The fastening portion 32a has a substantially cylindrical shape. The shaft 31 is fastened to the fastening portion 32a by press-fit. The upper cover portion 32b has a substantially disk-like shape and extends radially outward from the upper end of the fastening portion 32a. The cylinder portion 32c has a substantially cylindrical shape and extends downward from the radial outer edge of the upper cover portion 32b. The cylinder portion 32c is arranged in a coaxial relationship with the center axis 9. The flange portion 32d has a substantially annular shape and protrudes radially outward from the lower end of the cylinder portion 32c.

The rotor holder 32 is produced by press-forming a metal plate, e.g., a zinc-coated steel plate. Alternatively, the rotor holder 32 may be produced by other methods such as cutting or the like.

The rotor magnet 33 is a ring-shaped permanent magnet and is fixed to the inner circumferential surface of the cylinder portion 32c of the rotor holder 32. The rotor magnet 33 is one example of the first magnet of the present invention. The inner circumferential surface of the rotor magnet 33 is a magnetic pole surface radially opposed to the end surfaces of the tooth portions 24a of the stator core 24.

The turntable 34 is a member fixed to the rotor holder 32 for rotation with the rotor holder 32. The turntable 34 is molded with a molding resin such as a polycarbonate or the like. In the present preferred embodiment, the rotor holder 32 and the turntable 34 are unified by insert-molding. Thus, the rotor holder 32 and the turntable 34 are kept firmly fixed to each other.

The turntable 34 preferably includes a flat plate portion 34a, a ball retainer portion 34b, a protrusion portion 34c, a covering portion 34d and an engagement portion 34e. The flat plate portion 34a is a substantially disk-shaped portion positioned below the cone 37. The ball retainer portion 34b is a portion arranged radially outward of the flat plate portion 34a to retain the balls 35 in place. An upwardly-opened annular groove portion 41 is formed in the ball retainer portion 34b. The balls 35 are accommodated within the groove portion 41 for rolling movement in the circumferential direction. The upper end of the groove portion 41 is closed by an annular cover member 42.

The balls 35 serve to correct the positional deviation of the gravity center of the rotary unit 3 and the disk 90 as a whole with respect the center axis 9. The rotary unit 3 and the disk 90 are rotated during operation of the brushless motor 13. If the rotation speed of the rotary unit 3 and the disk 90 becomes equal to or greater than a specified value, the balls 35 make rolling movement in the opposite direction to the gravity center with respect to the center axis 9. Consequently, the position of the gravity center of the rotary unit 3 and the disk 90 as a whole is adjusted to come closer to the center axis 9.

The protrusion portion 34c is a portion protruding radially outward from the upper end of the outer circumferential surface of the ball retainer portion 34b. The protrusion portion 34c is positioned higher than the cylinder portion 32c of the rotor holder 32 and protrudes radially outwards beyond the cylinder portion 32c. The disk support portion 36 is fixed to the upper surface of the protrusion portion 34c. The upper surface of the disk support portion 36 serves as a support surface on which the disk 90 is placed.

The covering portion 34d is a substantially cylindrical portion extending downwards from the radial inner end of the protrusion portion 34c. The covering portion 34d is arranged radially outward of the cylinder portion 32c and the flange portion 32d of the rotor holder 32. Thus, the outer circumferential surfaces of the cylinder portion 32c and the flange portion 32d are covered with the covering portion 34d which is a resin layer. The radial outer end portion of the rotor holder 32 is positioned radially inward of the outer circumferential surface of the covering portion 34d.

In the insert-molding process to be described below, the covering portion 34d is interposed between the outer circumferential surfaces of the cylinder portion 32c and the flange portion 32d of the rotor holder 32 and the mold 51. For this reason, the outer circumferential surfaces of the cylinder portion 32c and the flange portion 32d do not make direct contact with the mold 51. Thus, the outer circumferential surfaces of the cylinder portion 32c and the flange portion 32d do not make sliding contact with the mold 51 when the rotor holder 32 and the turntable 34 are removed from the mold 51. This assists in suppressing wear of the mold 51 in the molding process. As a result, it is possible to perform the insert-molding with the same mold at the greater number of times than when the outer circumferential surfaces of the cylinder portion 32c and the flange portion 32d would make sliding contact with the mold 51. In other words, the number of times of the insert-molding operations that can be performed by the same mold 51 gets closer to the number of times of molding operations that can be performed by the mold of the same shape without insert-molding.

In particular, the rotor holder 32 can be produced more cost-effectively by press-forming than by cutting. If the rotor holder 32 is produced by press-forming, however, it is hard to increase the dimensional accuracy of the rotor holder 32. In case where the covering portion 34d does not exist on the outer circumferential surfaces of the cylinder portion 32c and the flange portion 32d, therefore, it is likely that strong sliding contact may occur between the outer circumferential surface of the cylinder portion 32c or the flange portion 32d and the mold 51. Such strong sliding contact is prevented in the present preferred embodiment because the outer circumferential surfaces of the cylinder portion 32c and the flange portion 32d are covered with the covering portion 34d.

The technical concept of suppressing the sliding contact between the rotor holder 32 and the mold by the provision of the covering portion 34d is especially useful in the event that the rotor holder 32 is a press-formed product.

In the present preferred embodiment, the metal-made rotor holder 32 and the resin-made turntable 34 are unified by insert-molding. This helps reduce vibration of the turntable 34 as compared with the case where the rotor holder 32 and the turntable 34 are fixed to each other by an adhesive agent or other materials. This assists in suppressing the noises generated by, e.g., the rolling movement of the balls 35.

Particularly, the turntable 34 of the present preferred embodiment is provided with the covering portion 34d. Thus, the rotor holder 32 and the turntable 34 are closely fixed to each other over a wide contact area, which further reduces the vibration of the turntable 34 or the noises. In addition, the rotor holder 32 and the turntable are more strongly fixed to each other than when the covering portion 34d would be absent.

The engagement portion 34e is a portion arranged radially inward of the cylinder portion 32c of the rotor holder 32 to make contact with the lower surface of the upper cover portion 32b. A through-hole 32e is defined in the upper cover portion 32b of the rotor holder 32 to bring the upper and lower sides of the upper cover portion 32b into communication with each other therethrough. The engagement portion 34e is connected to the flat plate portion 34a and the ball retainer portion 34b through the through-hole 32e. The engagement portion 34e is broadened in the horizontal direction from the lower end of the through-hole 32e. The upper surface of the engagement portion 34e remains in close contact with the lower surface of the upper cover portion 32b.

As set forth above, the engagement portion 34e has a shape capable of preventing separation of the rotor holder 32 and the turntable 34. Thus, the rotor holder 32 and the turntable 34 are fixed to each other in a stronger manner. In particular, it is possible to prevent separation of the rotor holder 32 and the turntable 34 which may occur when the rotor holder 32 and the turntable 34 unified together are removed from the open molds in the insert-molding process to be described below. The through-hole 32e may be defined in one place or plural places of the upper cover portion 32b. The engagement portion 34e may be formed annularly or discontinuously in a circumferential direction under the lower surface of the upper cover portion 32b.

The cone 37 is a member arranged to support the inner circumferential portion of the disk 90. The cone 37 is axially movably attached to the shaft 31 at the upper side of the flat plate portion 34a of the turntable 34. The cone 37 preferably includes a slant surface 37a whose diameter gets gradually increased downward. The cone 37 supports the disk 90 with the inner circumferential portion of the disk 90 kept in contact with the slant surface 37a. Thus, the center of the disk 90 is positioned on the center axis 9. That is to say, the cone 37 serves as a centering portion to decide the radial position of the disk 90.

An axially extendible spring member 40 is arranged between the flat plate portion 34a of the turntable 34 and the cone 37. The spring member 40 biases the cone 37 upwards. The yoke 38 is a magnetic body fixed to the upper end portion of the shaft 31. The cone 37 stays in contact with the lower surface of the yoke 38 when the disk 90 is not held in position. The yoke 38 generates a magnetic attraction force between itself and the clamp magnet provided in the clamper 14. This attraction force causes the disk 90 to be gripped between the disk support portion 36, the cone 37 and the clamper 14.

The preload magnet 39 is a ring-shaped permanent magnet. The preload magnet 39 is fixed to the lower surface of the upper cover portion 32b of the rotor holder 32. The preload magnet 39 is one example of the second magnet of the present invention. By virtue of the axial magnetic attraction force generated between the preload magnet 39 and the stationary bearing unit 22, the rotary unit 3 is attracted toward the stationary unit 2, thereby stabilizing the rotation posture of the rotary unit 3.

If a drive current is applied to the coils 25 of the stationary unit 2 of the brushless motor 13, magnetic flux is generated in the tooth portions 24a of the stator core 24. Circumferentially-acting torque is generated under the action of the magnetic flux flowing between the tooth portions 24a and the rotor magnet 33. This torque causes the rotary unit 3 to rotate about the center axis 9 with respect to the stationary unit 2. The disk 90 held in the rotary unit 3 is rotated about the center axis 9 together with the rotary unit 3.

<2-3. Steps of Insert-Molding>

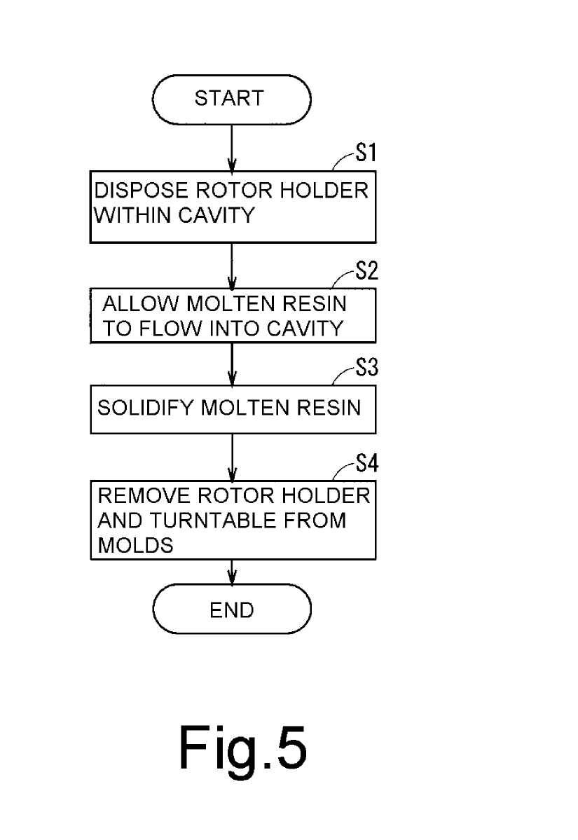

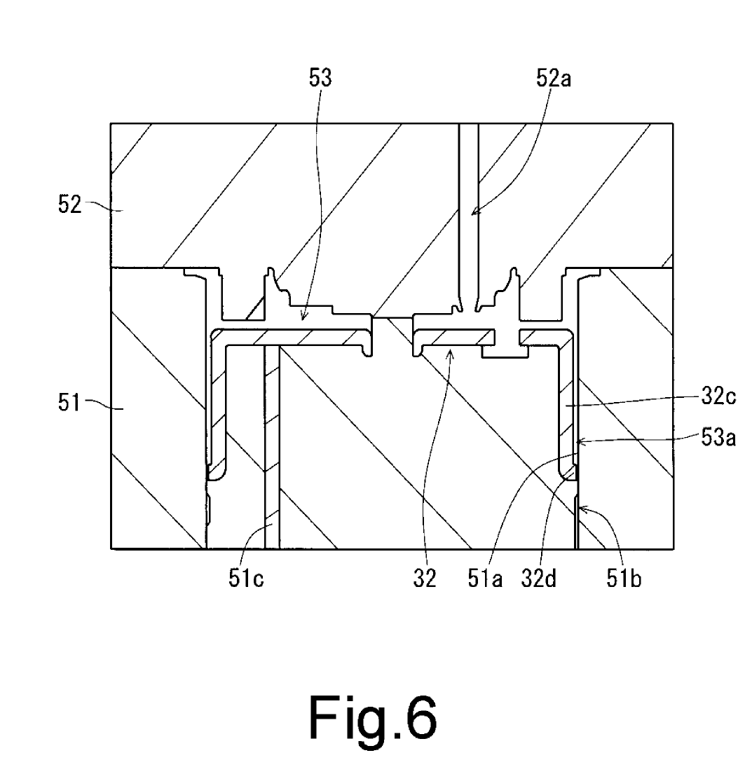

Next, description will be made on the steps of unifying the rotor holder 32 and the turntable 34 through insert-molding in the manufacturing process of the brushless motor 13. FIG. 5 is a flowchart illustrating the insert-molding steps. FIGS. 6 through 9 are section views showing different insert-molding states in the respective insert-molding steps.

A pair of molds 51 and 52 and a preliminarily manufactured rotor holder 32 are prepared in order to perform the insert-molding. As mentioned earlier, the rotor holder 32 is produced by, e.g., press-forming or cutting. A cavity 53 is defined inside the molds 51 and 52 by bringing the opposing surfaces of the molds 51 and 52 into contact with each other. The cavity 53 has a shape corresponding to the unified shape of the rotor holder 32 and the turntable 34.

First, the rotor holder 32 is set within the mold 51. Then, the opposing surfaces of the molds 51 and 52 are brought into contact with each other to define the cavity 53 inside the molds 51 and 52. Thus, the rotor holder 32 is disposed within the cavity 53 (step S1 and FIG. 6). As shown in FIG. 6, the mold 51 includes an inner circumferential surface 51a having a diameter greater than that of the outer circumferential surface of the cylinder portion 32c of the rotor holder 32. Therefore, a substantially cylindrical gap 53a is defined between the outer circumferential surface of the cylinder portion 32c and the inner circumferential surface 51a of the mold 51. The gap 53a forms a portion of the cavity 53.

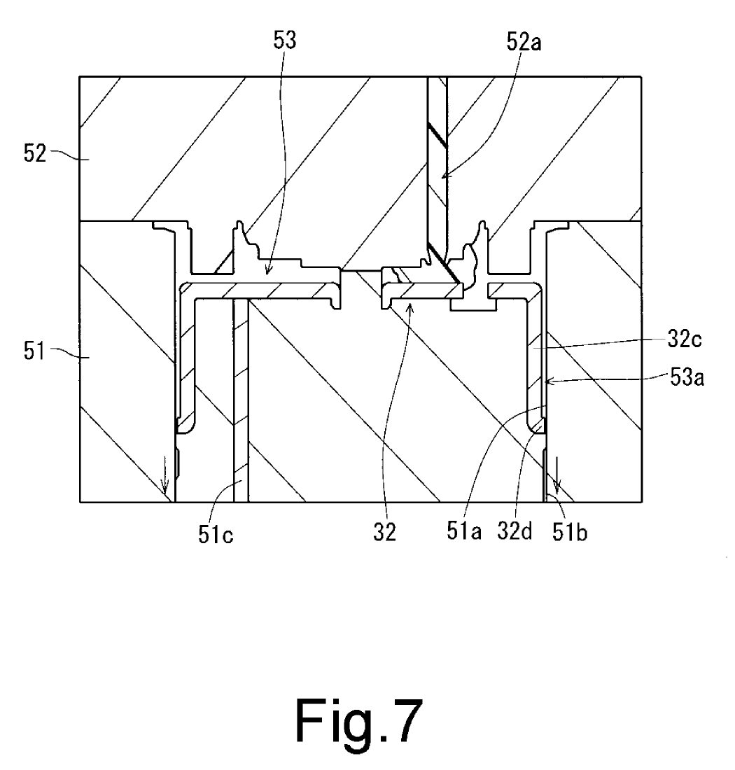

Next, a molten resin is allowed to flow into the cavity 53 through a gate 52a formed in the mold 52 (step S2 and FIG. 7). The molten resin is filled in the cavity 53 excluding the space occupied by the rotor holder 32. The mold 51 employed in the present preferred embodiment has a vent hole 51b communicating with the lower end of the cylindrical gap 53a. The vent hole 51b is connected to a vacuum generating mechanism (not shown). In step S2, the molten resin is introduced into the cavity 53 while expelling the air in the cavity 53 through the vent hole 51b. This enables the molten resin to uniformly spread up to the lower end of the cylindrical gap 53a within the cavity 53.

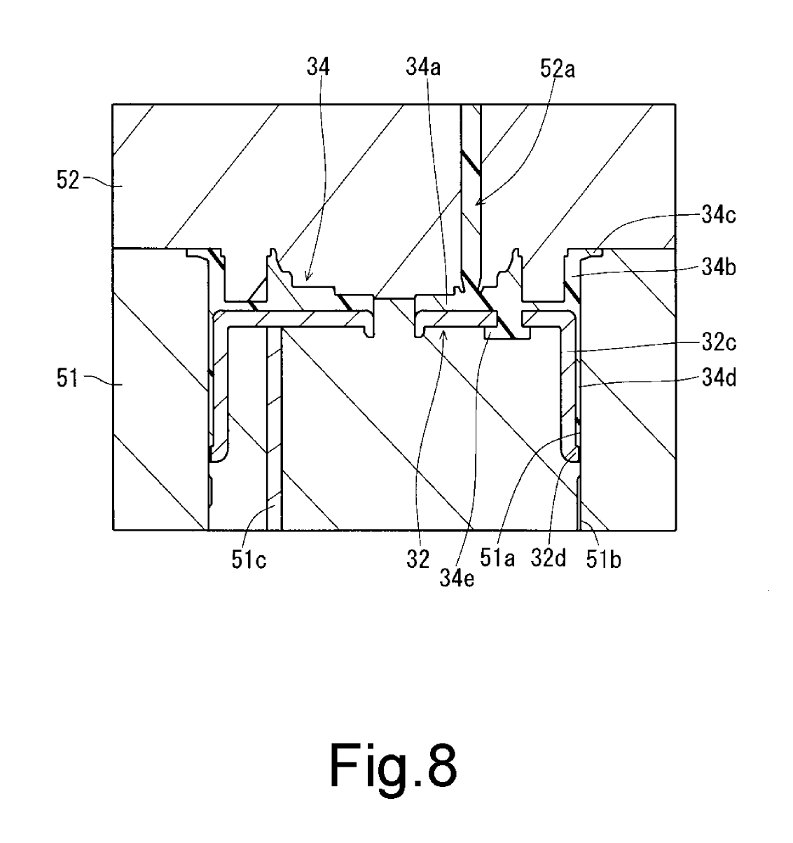

Subsequently, the molten resin in the cavity 53 is cooled and solidified (step S3 and FIG. 8). When solidified, the resin in the cavity 53 is formed into a turntable 34. As a consequence, the rotor holder 32 and the turntable 34 are unified together.

The turntable 34 molded through the aforementioned steps is shaped to include a flat plate portion 34a, a ball retainer portion 34b, a protrusion portion 34c, a covering portion 34d and an engagement portion 34e. The resin filled in the cylindrical gap 53a is formed into the covering portion 34d as it solidifies. As a result, the cylinder portion 32c and the flange portion 32d of the rotor holder 32 are covered with the covering portion 34d as a resin layer.

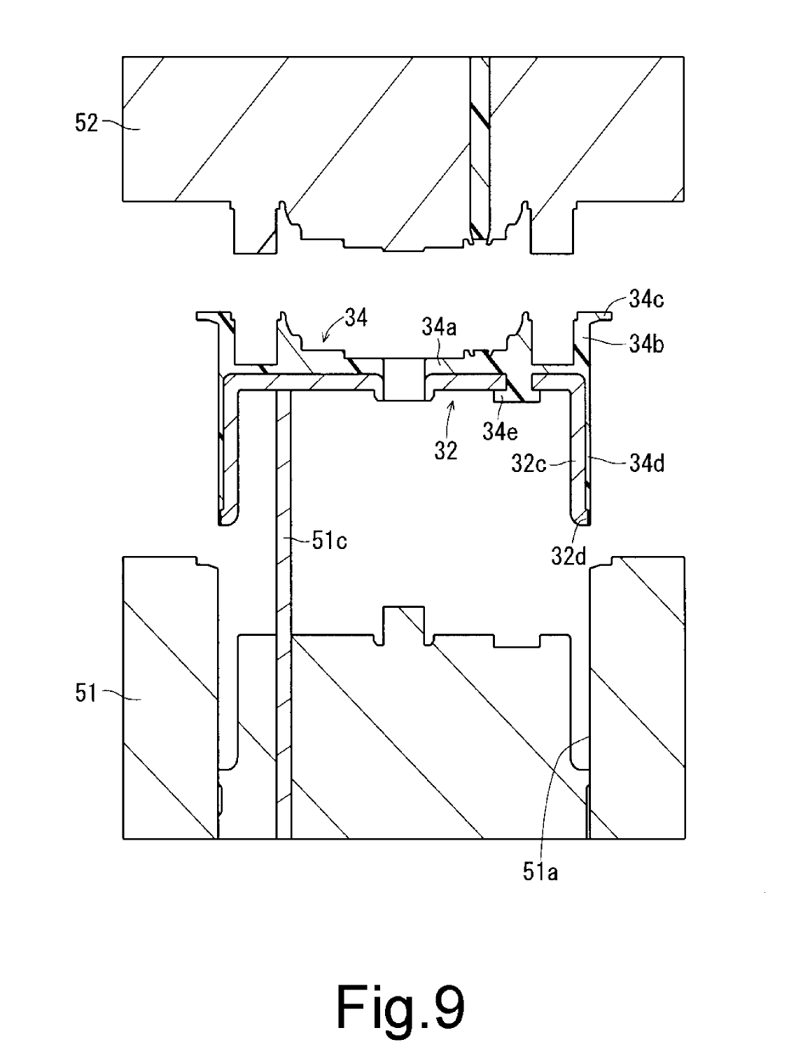

Thereafter, the molds 51 and 52 are opened while allowing release pins 51c to strike against the rotor holder 32 and the turntable 34 and protrude from the mold 51. Consequently, the rotor holder 32 and the turntable 34 unified together are removed from the molds 51 and 52 (step S4 and FIG. 9). Since the cylinder portion 32c is covered with the covering portion 34d at this time, the inner circumferential surface 51a of the mold 51 does not make sliding contact with the outer circumferential surfaces of the cylinder portion 32c and the flange portion 32d, thereby suppressing wear of the mold 51. As a result, it is possible to perform the insert-molding with the same mold 51 at the greater number of times than when the mold 51 would make sliding contact with the outer circumferential surfaces of the cylinder portion 32c and the flange portion 32d. In other words, the number of times of the insert-molding operations that can be performed by the same mold 51 gets closer to the number of times of molding operations that can be performed by the mold of the same shape without insert-molding.

### 3. Other Type of Motor

The description made in respect of the foregoing preferred embodiment is directed to a so-called sliding-cone-type motor including the cone 37 axially movable with respect to the shaft 31. However, the present invention may be applied to other types of motors.

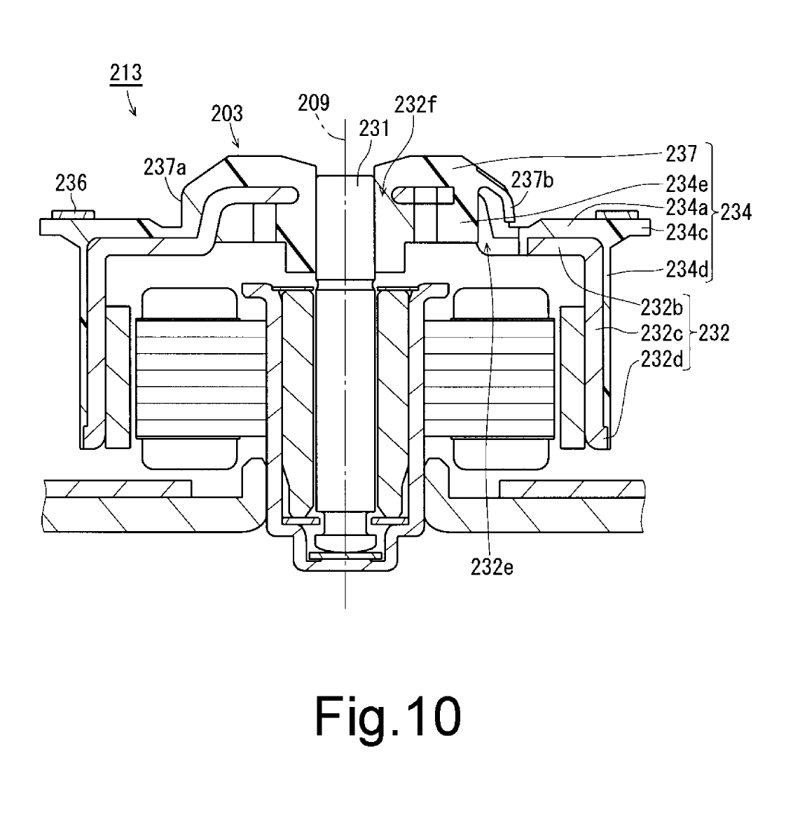

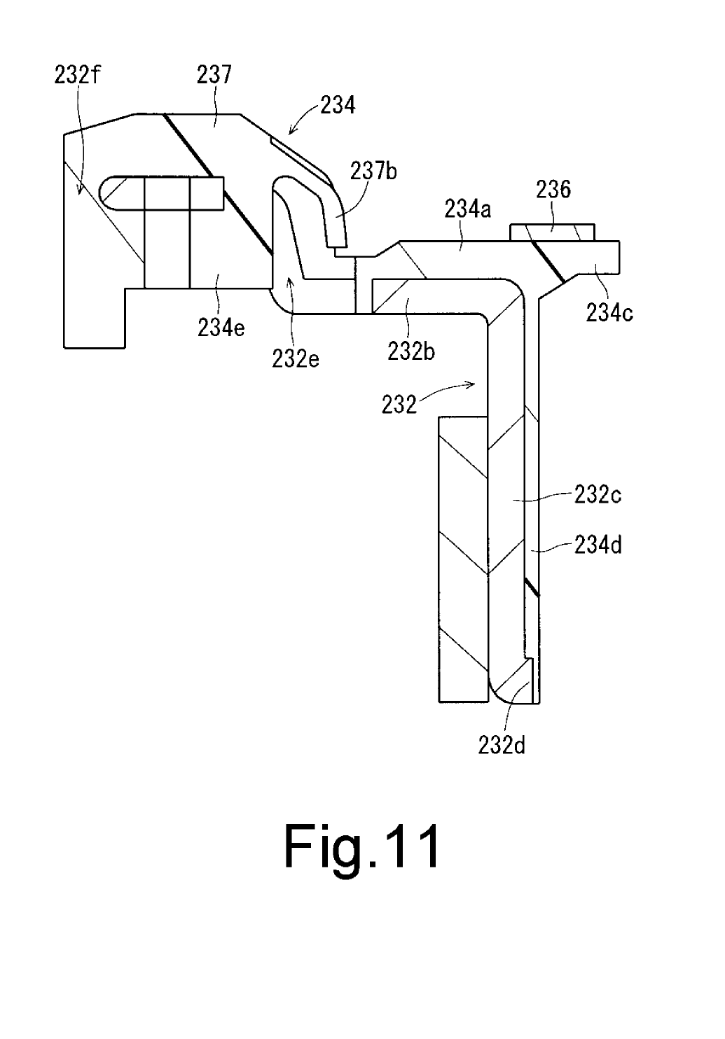

FIG. 10 is a vertical section view showing another type of brushless motor 213 according to one preferred embodiment of the present invention. FIG. 11 is a partial vertical section view showing a rotary unit 203 employed in the brushless motor 213.

The brushless motor 213 shown in FIG. 10 is a centering-claw-type motor including a centering portion 237 unified with a turntable 234. The following description will be focused on the points differing from the above-described brushless motor 13, and redundant descriptions of the same points as the brushless motor 13 will be omitted.

The rotor holder 232 of the brushless motor 213 preferably includes an upper cover portion 232b, a cylinder portion 232c and a flange portion 232d. The upper cover portion 232b is a portion extending radially inward from the upper end of the cylinder portion 232c. The cylinder portion 232c is a substantially cylindrical portion arranged in a coaxial relationship with the center axis 209. The flange portion 232d is a substantially annular portion protruding radially outward from the lower end of the cylinder portion 232c.

The turntable 234 is unified with the rotor holder 232 by the insert-molding described above. The shaft 231 is press-fitted to the turntable 234 and fixed to the turntable 234 by an adhesive agent.

The turntable 234 preferably includes the centering portion 237, a flat plate portion 234a, a protrusion portion 234c, a covering portion 234d and an engagement portion 234e. The centering portion 237 preferably includes a guide surface 237a arranged to guide the inner circumferential portion of a disk. The centering portion 237 further includes centering claws 237b arranged at plural points along the circumferential direction. The centering claws 237b are flexible in the radial direction. The centering portion 237 supports the disk in a state that the inner circumferential portion of the disk is in contact with the centering claws 237b. Thus, the center of the disk is positioned on the center axis 209.

The flat plate portion 234a is a substantially disk-shaped portion extending radially outward from the outer edge of the centering portion 237. The protrusion portion 234c is a portion protruding radially outward from the outer edge of the flat plate portion 234a. The protrusion portion 234c is positioned higher than the cylinder portion 232c of the rotor holder 232 and protrudes radially outward beyond the cylinder portion 232c. A disk support portion 236 is fixed to the upper surface of the protrusion portion 234c.

The covering portion 234d is a substantially cylindrical portion extending downward from the radial inner end of the protrusion portion 234c. The covering portion 234d is arranged radially outward of the cylinder portion 232c and the flange portion 232d of the rotor holder 232. Thus, the outer circumferential surfaces of the cylinder portion 232c and the flange portion 232d are covered with the covering portion 234d as a resin layer. The radial outer end portion of the rotor holder 232 is arranged radially inward of the outer circumferential surface of the covering portion 234d.

In the insert-molding process to be described below, the covering portion 234d is interposed between the outer circumferential surfaces of the cylinder portion 232c and the flange portion 232d of the rotor holder 232 and the mold 251. For this reason, the outer circumferential surfaces of the cylinder portion 232c and the flange portion 232d do not make direct contact with the mold 251. Thus, the mold 251 does not make sliding contact with the outer circumferential surfaces of the cylinder portion 232c and the flange portion 232d when the rotor holder 232 and the turntable 234 are removed from the mold 251. This assists in suppressing wear of the mold 251. As a result, it is possible to perform the insert-molding with the same mold 251 at the greater number of times than when the mold 251 would make sliding contact with the outer circumferential surfaces of the cylinder portion 232c and the flange portion 232d. In other words, the number of times of the insert-molding operations that can be performed by the same mold 251 gets closer to the number of times of molding operations that can be performed by the mold of the same shape without insert-molding.

As in the brushless motor 13 of the foregoing preferred embodiment, the vibration of the turntable 234 and the noises are reduced in the brushless motor 213. In addition, just like the brushless motor 13 of the foregoing preferred embodiment, the rotor holder 232 and the turntable 234 are strongly fixed to each other in the brushless motor 213.

The engagement portion 234e is a portion formed radially inward of the cylinder portion 232c of the rotor holder 232 to make contact with the lower surface of the upper cover portion 232b. The upper cover portion 232b of the rotor holder 232 has through-holes 232e defined below the respective centering claws 237b. The rotor holder 232 is not directly fixed to the shaft 231. An annular gap portion 232f is defined between the outer circumferential surface of the shaft 231 and the upper cover portion 232b of the rotor holder 232. In other words, the rotor holder 232 is fixed to the shaft 231 with the gap portion 232f interposed therebetween. The engagement portion 234e is joined to the centering portion 237 through the through-holes 232e and the gap portion 232f. Moreover, the engagement portion 234e extends between the lower areas of the through-holes 232e and the lower area of the gap portion 232f. The upper surface of the engagement portion 234e remains in close contact with the lower surface of the upper cover portion 232b.

As set forth above, the engagement portion 234e has a shape capable of preventing separation of the rotor holder 232 and the turntable 234. Thus, the rotor holder 232 and the turntable 234 are fixed to each other in a stronger manner. In particular, it is possible to prevent separation of the rotor holder 232 and the turntable 234 which may occur when the rotor holder 232 and the turntable 234 unified together are removed from the open molds in the insert-molding process to be described below. The engagement portion 234e may be formed annularly or discontinuously in a circumferential direction under the lower surface of the upper cover portion 232b.

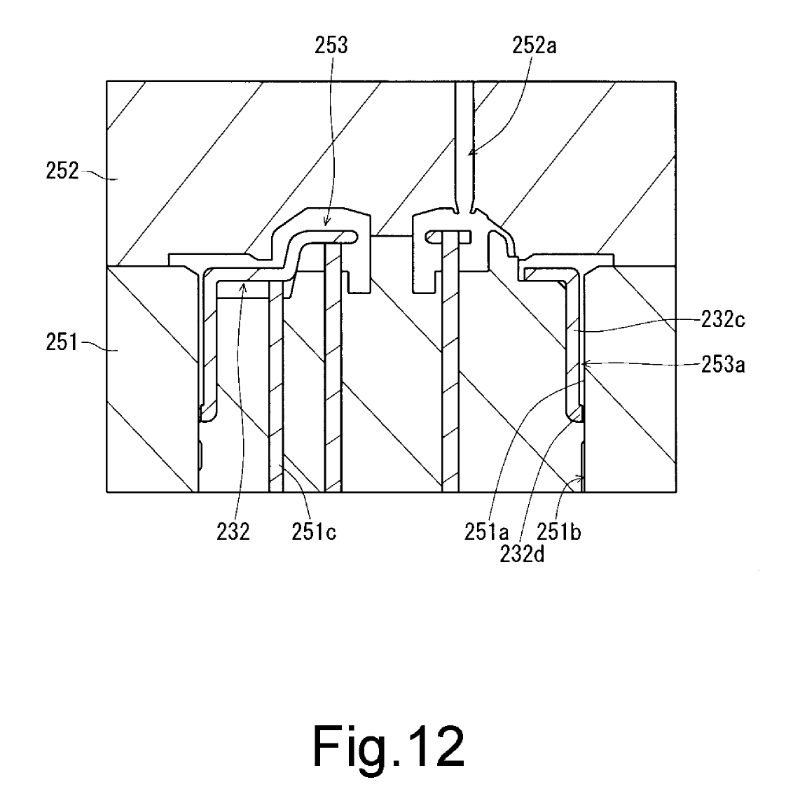

The steps of unifying the rotor holder 232 and the turntable 234 through insert-molding in the manufacturing process of the brushless motor 213 will be described with reference to the flowchart illustrated in FIG. 5. FIGS. 12 through 15 are section views showing different insert-molding states in the respective insert-molding steps.

A pair of molds 251 and 252 and a preliminarily manufactured rotor holder 232 are prepared in order to perform the insert-molding. The rotor holder 232 is produced by, e.g., press-forming or cutting. A cavity 253 is defined inside the molds 251 and 252 by bringing the opposing surfaces of the molds 251 and 252 into contact with each other. The cavity 253 has a shape corresponding to the unified shape of the rotor holder 232 and the turntable 234.

First, the rotor holder 232 is set within the mold 251. Then, the opposing surfaces of the molds 251 and 252 are brought into contact with each other to define the cavity 253 inside the molds 251 and 252. Thus, the rotor holder 232 is disposed within the cavity 253 (step S1 and FIG. 12). As shown in FIG. 12, the mold 251 includes an inner circumferential surface 251a having a diameter greater than that of the outer circumferential surface of the cylinder portion 232c of the rotor holder 232. Therefore, a substantially cylindrical gap 253a is defined between the outer circumferential surface of the cylinder portion 232c and the inner circumferential surface 251a of the mold 251. The gap 253a forms a portion of the cavity 253.

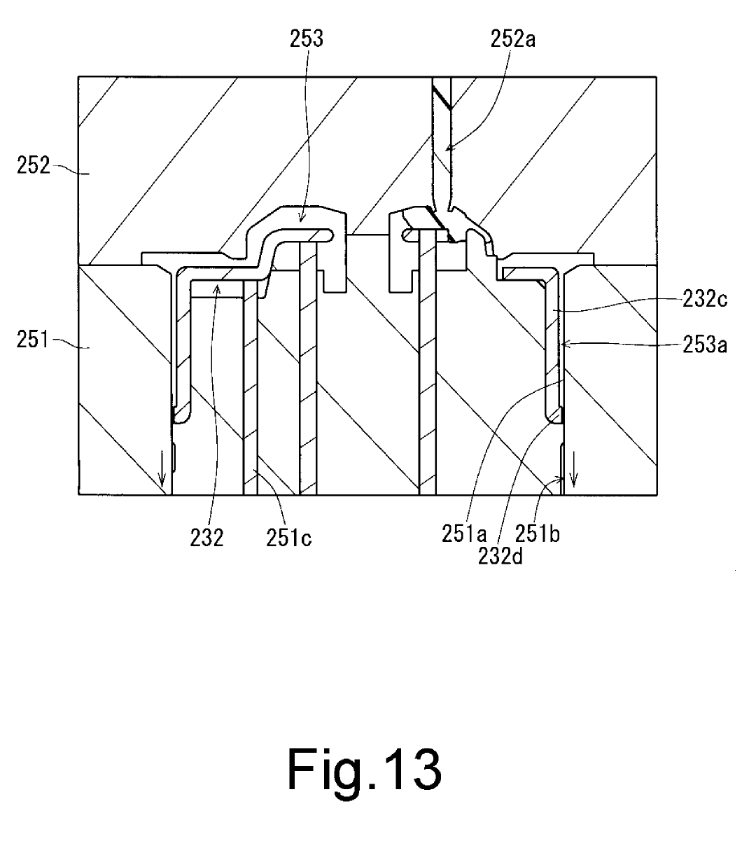

Next, a molten resin is allowed to flow into the cavity 253 through a gate 252a formed in the mold 252 (step S2 and FIG. 13). The molten resin is filled in the cavity 253 excluding the space occupied by the rotor holder 232. The mold 251 employed in the present preferred embodiment has a vent hole 251b communicating with the lower end of the cylindrical gap 253a. The vent hole 251b is connected to a vacuum generating mechanism (not shown). In step S2, the molten resin is introduced into the cavity 253 while expelling the air in the cavity 253 through the vent hole 251b. This enables the molten resin to uniformly spread up to the lower end of the cylindrical gap 253a within the cavity 253.

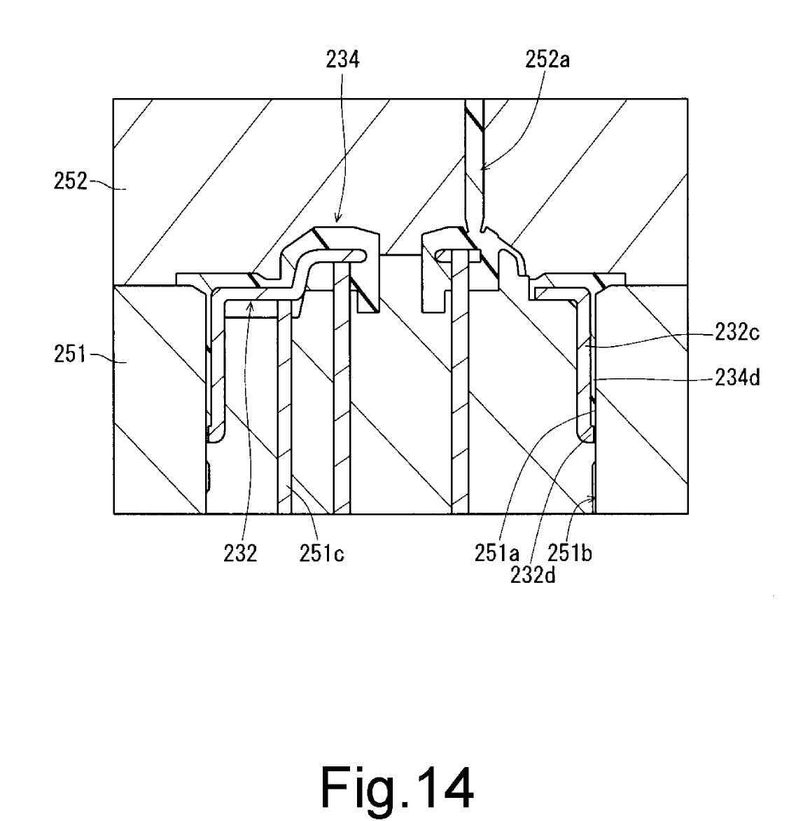

Subsequently, the molten resin in the cavity 253 is cooled and solidified (step S3 and FIG. 14). When solidified, the resin in the cavity 253 is formed into a turntable 234. As a consequence, the rotor holder 232 and the turntable 234 are unified together.

The turntable 234 molded through the aforementioned steps is shaped to include a centering portion 237, a flat plate portion 234a, a protrusion portion 234c, a covering portion 234d and an engagement portion 234e. The resin filled in the cylindrical gap 253a is formed into the covering portion 234d as it solidifies. As a result, the cylinder portion 232c and the flange portion 232d of the rotor holder 232 are covered with the covering portion 234d as a resin layer.

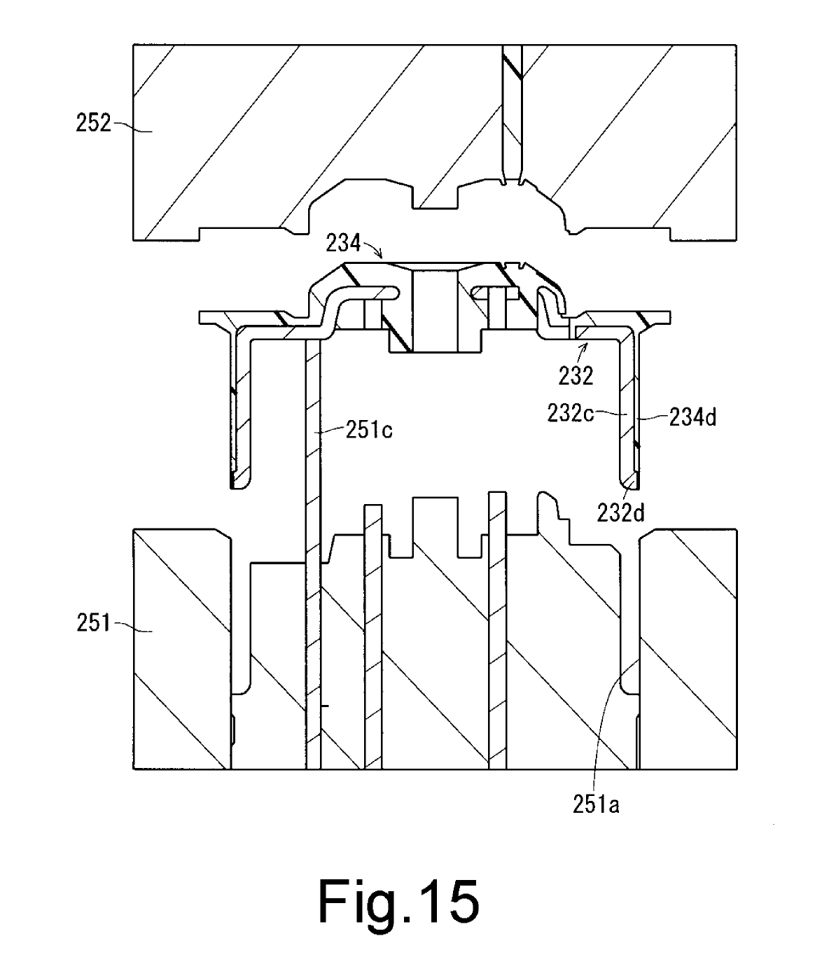

Thereafter, the molds 251 and 252 are opened while allowing release pins 251c to strike against the rotor holder 232 and the turntable 234 unified together and protrude from the mold 251. Consequently, the rotor holder 232 and the turntable 234 unified together are removed from the molds 251 and 252 (step S4 and FIG. 15). At this time, the inner circumferential surface 251a of the mold 251 does not make sliding contact with the outer circumferential surfaces of the cylinder portion 232c and the flange portion 232d, thereby suppressing wear of the mold 251. As a result, it is possible to perform the insert-molding with the same mold 251 at the greater number of times than when the mold 251 would make sliding contact with the outer circumferential surfaces of the cylinder portion 232c and the flange portion 232d. In other words, the number of times of the insert-molding operations that can be performed by the same mold 251 gets closer to the number of times of molding operations that can be performed by the mold of the same shape without insert-molding.

### 4. Modified Embodiments

While preferred embodiments of the present invention have been described hereinabove, the present invention is not limited the foregoing embodiments. A variety of modified embodiments will now be described with emphasis placed on the points differing from the foregoing embodiments.

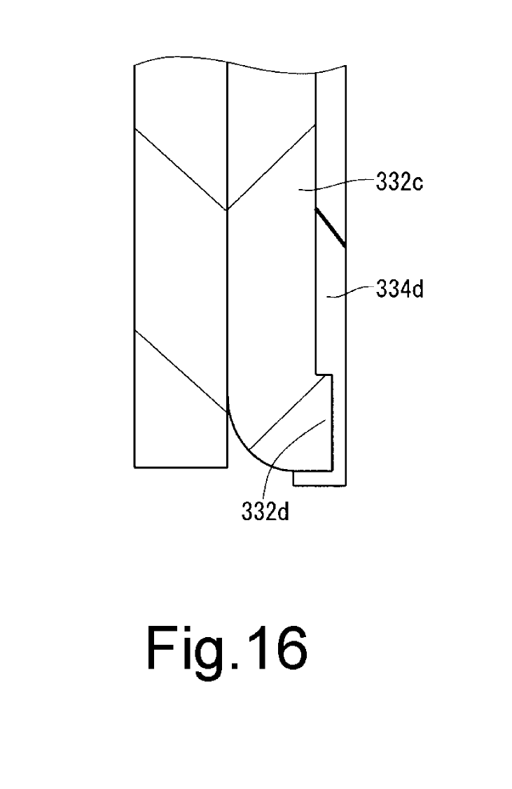

FIG. 16 is a partial vertical section view of the flange portion 332d of the rotor holder and its vicinities, showing one modified embodiment of the present invention. In the modified embodiment shown in FIG. 16, the covering portion 334d covers not only the outer circumferential surfaces of the cylinder portion 332c and the flange portion 332d but also the lower surface of the flange portion 332d. The contact area between the rotor holder and the turntable can be further increased by allowing the covering portion 334d to cover at least a portion of the lower end surface of the rotor holder. This helps further reduce the vibration of the turntable and the noises. Moreover, the rotor holder and the turntable are fixed to each other in a stronger manner.

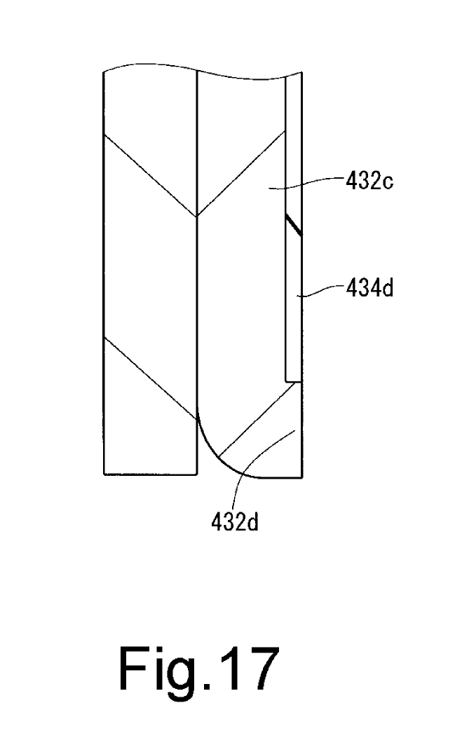

FIG. 17 is a partial vertical section view of the flange portion 432d of the rotor holder and its vicinities, showing another modified embodiment of the present invention. In the modified embodiment shown in FIG. 17, the radial outer end of the flange portion 432d and the outer circumferential surface of the covering portion 434d are arranged substantially in the same radial position. In other words, the radius of the outer circumferential surface of the covering portion 434d measured from the center axis is substantially equal to the radius of the outer circumferential surface of the flange portion 432d measured from the center axis. Thus, only the outer circumferential surface of the cylinder portion 432c is covered with the covering portion 434d.

In this case, the outer circumferential surface of the flange portion 432d may possibly make contact with the mold during the insert-molding process. Even if the structure shown in FIG. 17 is employed, however, it is possible to reduce the contact area between the rotor holder and the mold as compared with the conventional case. Accordingly, the sliding contact between the mold and the rotor holder can be suppressed in the modified embodiment shown in FIG. 17. This helps suppress wear of the mold. In addition, if the structure shown in FIG. 17 is employed, it is possible to reduce the radial dimension of the covering portion 434d as compared with the foregoing preferred embodiments.

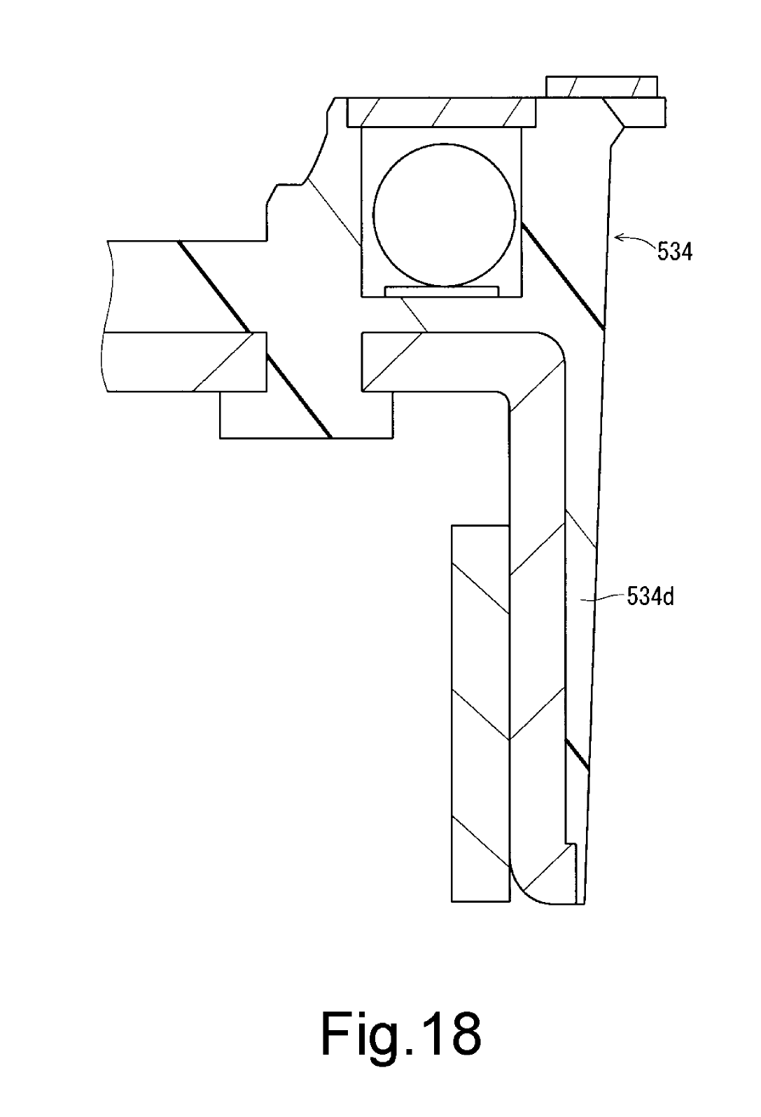

FIG. 18 is a partial vertical section view of the outer circumferential portion of the rotary unit and its vicinities, showing a further modified embodiment of the present invention. In the modified embodiment shown in FIG. 18, the radius of the outer circumferential surface of the covering portion 534d measured from the center axis gets gradually increased upward. In other words, the outer circumferential surface of the covering portion 534d is formed into a tapering shape. This makes it possible to easily remove the turntable 534 from the mold in the insert-molding process. Moreover, it is possible to increase the thickness of the upper portion of the turntable 534, thereby enhancing the stiffness and fixing strength of the turntable 534.

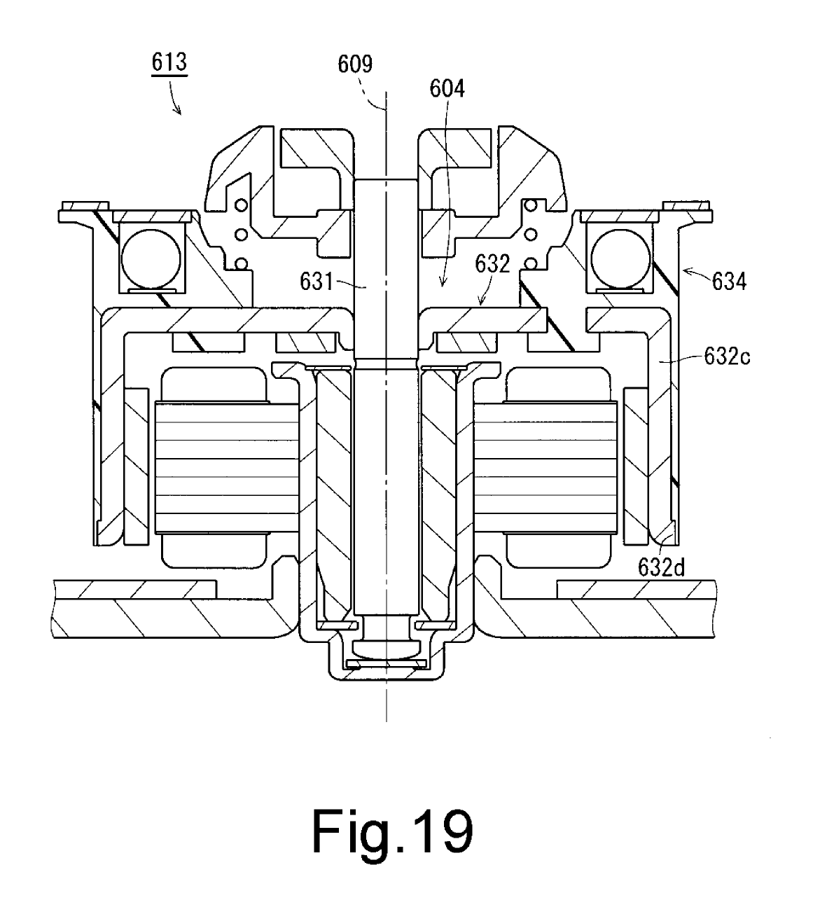

FIG. 19 is a vertical section view of a brushless motor 613, showing a still further modified embodiment of the present invention. In the modified embodiment shown in FIG. 19, at least a portion of the upper surface of the rotor holder 632 is exposed to the outside (not covered with a resin). More specifically, the radial inner area of the upper surface of the rotor holder 632 is exposed in an annular shape surrounding the shaft 631 and is not covered with a resin. Thus, the inner circumferential surface of the turntable 634 is spaced apart from the outer circumferential surface of the shaft 631. In case where the rotor holder 632 and the turntable 634 are unified together by insert-molding, the relative position of the turntable 634 with respect to the rotor holder 632 is determined during the insert-molding process. For that reason, if the insert-molding accuracy and the attachment accuracy of the rotor holder 632 relative to the shaft 631 are all high enough, the concentricity of the turntable 634 relative to a center axis 609 becomes highly accurate. In this case, there is no need to bring the inner circumferential surface of the turntable 634 into contact with the outer circumferential surface of the shaft 631.

In the modified embodiment shown in FIG. 19, the space 604 defined between the inner circumferential surface of the turntable 634 and outer circumferential surface of the shaft 631 may be used for other purposes. This makes it possible to design, with increased freedom, the position and dimension of the individual members existing around the space 604. Use of the structure shown in FIG. 19 makes it possible to cut down the quantity of the resin required in the insert-molding and to reduce the volume of the turntable 634. This enables a resin to easily and uniformly spread through the narrow gap between the cylinder portion 632c, the flange portion 632d and the mold during the insert-molding process.

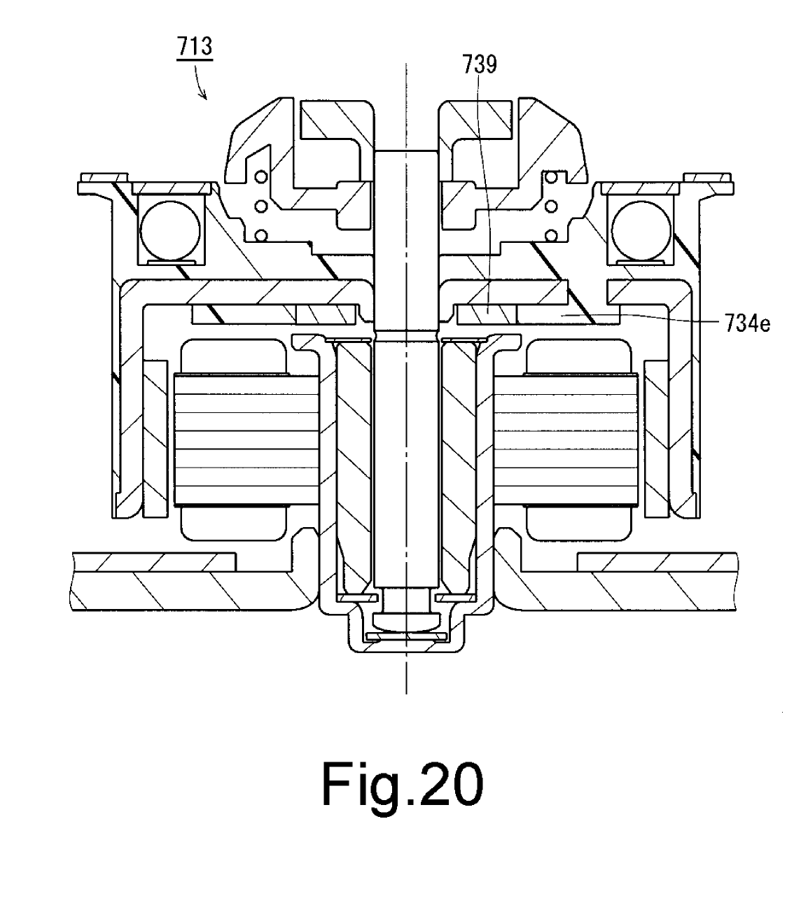

FIG. 20 is a vertical section view of a brushless motor 713, showing a yet still further modified embodiment of the present invention. In the modified embodiment shown in FIG. 20, the outer circumferential surface of the preload magnet 739 is kept in contact with the inner circumferential surface of the engagement portion 734e. In the manufacturing process of the brushless motor 713, the inner circumferential surface of the engagement portion 734e is formed in the position corresponding to the outer circumferential surface of the preload magnet 739 during the insert-molding. After the insert-molding, the preload magnet 739 is inserted inside the inner circumferential surface of the engagement portion 734e.

This makes it possible to easily determine the position of the preload magnet 739 on the basis of the inner circumferential surface of the engagement portion 734e. If the preload magnet 739 is positioned in a highly accurate manner, it is possible to suppress the magnetic vibration or other problems caused by the positional deviation of the preload magnet 739. The outer circumferential surface of the preload magnet 739 may make contact with the inner circumferential surface of the engagement portion 734e either over the full circumference or in part.

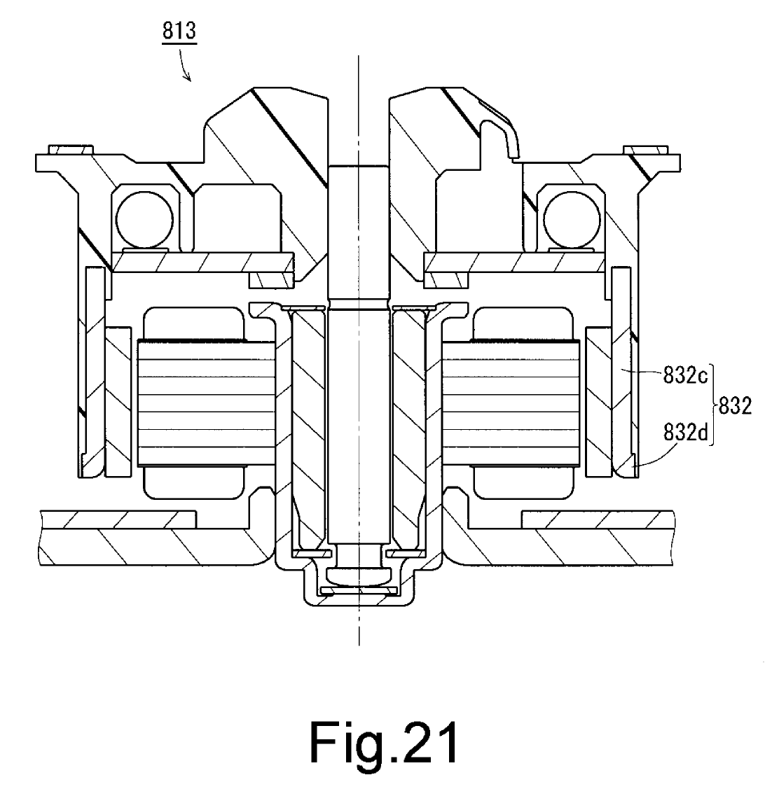

FIG. 21 is a vertical section view of a brushless motor 813, showing a yet still further modified embodiment of the present invention. In the modified embodiment shown in FIG. 21, the rotor holder 832 includes only a cylinder portion 832c and a flange portion 832d. In this way, the motor of the present invention may be provided with the rotor holder 832 having no upper cover portion. Although not shown in the drawings, the rotor holder employed in the motor of the present invention may have no flange portion.

The motor of the present invention may be used to hold the optical disk as in the foregoing preferred embodiments or to hold other removable recording disks such as a magnetic disk and the like.

The present invention can find its application in a motor, a disk drive apparatus and a motor manufacturing method.

While various preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor, comprising:
a stationary unit; and
a rotary unit supported by the stationary unit for rotation with respect to the stationary unit,
wherein the rotary unit includes a shaft arranged along a vertically-extending center axis, a metal-made rotor holder having a cylinder portion arranged in a coaxial relationship with the center axis, a first magnet fixed to an inner circumferential surface of the cylinder portion, a resin-made turntable unified with the rotor holder by insert-molding and a disk support portion fixed to the turntable and provided with an upper surface on which a disk is to be placed,
the stationary unit includes a bearing unit arranged to rotatably support the shaft and a stator radially opposed to the first magnet,
the turntable includes a protrusion portion protruding radially outward beyond the cylinder portion of the rotor holder to support the disk support portion from below and a substantially cylindrical covering portion extending downward from an radial inner end of the protrusion portion to cover an outer circumferential surface of the cylinder portion, and
the rotor holder has a radial outer end portion arranged in the same radial position as an outer circumferential surface of the covering portion or arranged radially inward of the outer circumferential surface of the covering portion.

2. The motor of claim 1, wherein the rotor holder includes a flange portion protruding radially outward from the lower end of the cylinder portion, the covering portion being arranged to cover an outer circumferential surface of the flange portion.

3. The motor of claim 1, wherein the covering portion is arranged to cover at least a portion of the lower end of the rotor holder.

4. The motor of claim 1, wherein the rotor holder includes a flange portion protruding radially outward from the lower end of the cylinder portion, the diameter defined by the outer circumferential surface of the covering portion and the center axis being equal to the diameter defined by an outer circumferential surface of the flange portion and the center axis.

5. The motor of claim 1, wherein the diameter defined by the outer circumferential surface of the covering portion and the center axis is gradually increased upward.

6. The motor of claim 1, wherein the rotor holder further includes an upper cover portion extending radially inward from the upper end of the cylinder portion.

7. The motor of claim 6, wherein the turntable further includes an engagement portion in close contact with a lower surface of the upper cover portion.

8. The motor of claim 7, wherein the engagement portion is formed annularly or discontinuously in a circumferential direction under the lower surface of the upper cover portion.

9. The motor of claim 7, wherein the upper cover portion includes at least one through-hole defined to bring the upper and lower sides of the upper cover portion into communication with each other, the engagement portion being broadened radially from the lower end of the through-hole, the engagement portion having an upper surface kept in close contact with the lower surface of the upper cover portion.

10. The motor of claim 7, wherein the rotary unit further includes a substantially annular second magnet fixed to the lower surface of the upper cover portion and arranged to attract the rotary unit toward the stationary unit by a magnetic attraction force, the second magnet having an outer circumferential surface at least partially kept in contact with the engagement portion.

11. The motor of claim 1, wherein the rotor holder further includes a fastening portion fastened to the shaft, an outer circumferential surface of the shaft being spaced apart from an inner circumferential surface of the turntable.

12. The motor of claim 1, wherein the rotor holder further includes a fastening portion fastened to the shaft, the rotor holder having an upper surface at least partially exposed to the outside.

13. The motor of claim 1, wherein the rotor holder further includes a fastening portion fastened to the shaft, the shaft being press-fitted to the fastening portion.

14. The motor of claim 1, wherein the turntable further includes a substantially disk-shaped flat plate portion and a ball retainer portion arranged radially outward of the flat plate portion to hold a plurality of balls, the ball retainer portion having an upwardly-opened annular groove portion, the balls being accommodated within the groove portion for rolling movement in a circumferential direction.

15. The motor of claim 14, wherein the opening of the groove portion is closed by an annular cover member.

16. The motor of claim 1, wherein the turntable further includes a substantially disk-shaped flat plate portion, a cone axially movably attached to the shaft at the upper side of the flat plate portion and an axially-elastically deformable spring member arranged between the flat plate portion and the cone, the cone including a slant surface whose diameter gets gradually increased downward.

17. The motor of claim 1, wherein the turntable further includes a centering portion having a guide surface arranged to guide the inner circumferential portion of the disk and a substantially disk-shaped flat plate portion extending radially outward from the outer edge of the centering portion, the centering portion including radially-flexible centering claws arranged at plural points along a circumferential direction.

18. A disk drive apparatus comprising:
the motor of claim 1;
an access unit arranged to perform at least one of information reading and writing tasks with respect to the disk placed on the disk support portion of the motor; and
a housing arranged to accommodate the motor and the access unit.

19. A method for manufacturing a motor including a metal-made rotor holder having a cylinder portion arranged in a coaxial relationship with a center axis and a resin-made turntable having a protrusion portion protruding radially outward at the upper side of the cylinder portion, the method comprising:
disposing the rotor holder within a cavity defined between a pair of molds;
allowing a molten resin to flow into the cavity;
solidifying the resin in the cavity into the turntable to produce the turntable and the rotor holder unified together; and
removing the turntable and the rotor holder unified together from the molds,
wherein one of the molds includes an inner circumferential surface greater in diameter than an outer circumferential surface of the cylinder portion, and
the rotor holder is disposed in said one of the molds in such a way that the outer circumferential surface of the cylinder portion and the inner circumferential surface of said one of the molds are opposed to each other through a substantially cylindrical gap forming a portion of the cavity.

20. The method of claim 19, wherein said one of the molds includes a vent hole communicating with the lower end of the substantially cylindrical gap, the molten resin being allowed to flow into the cavity while expelling an air in the cavity through the vent hole.
